(19) United States
(12) Patent Application Publication
(10) Pub. No.: US 2025/0346180 A1
(43) Pub. Date: Nov. 13, 2025

(54) DRIVING ASSISTANCE SYSTEM, DRIVING ASSISTANCE METHOD, AND DRIVING ASSISTANCE PROGRAM

(71) Applicant: J-QuAD DYNAMICS Inc., Tokyo (JP)

(72) Inventors: Yuki YAMAMOTO, Tokyo (JP); Koji SHIBATA, Tokyo (JP); Ryu KAMBARA, Tokyo (JP); Nobuyuki IMODA, Tokyo (JP)

(21) Appl. No.: 19/073,086

(22) Filed: Mar. 7, 2025

(30) Foreign Application Priority Data
May 10, 2024 (JP) 2024-077254

(51) Int. Cl. B60Q 1/50; B60W 30/18; B60W 50/00

(52) U.S. Cl. CPC B60Q 1/543; B60W 30/18159; B60W 30/18163; B60W 50/0097; B60Q 2400/50; B60W 2540/18

(57) ABSTRACT

A driving assistance system, a driving assistance method, a non-transitory computer-readable storage medium storing a driving assistance program for assisting driving of a host vehicle plans a behavior change that is a change in a driving behavior controlled in the host vehicle, and projects a notification image that provides notification of a transition state of the behavior change onto a traveling road to cause a different road user to recognize the notification image, the different road user being expected to interact with the host vehicle.

### CROSS REFERENCE TO RELATED APPLICATION

The present application claims the benefit of priority from Japanese Patent Application No. 2024-077254 filed on May 10, 2024. The entire disclosure of the above application is incorporated herein by reference.

### TECHNICAL FIELD

The present disclosure relates to a driving assistance technology that assists driving of a host vehicle.

### BACKGROUND

In a comparative technology, lane changes are controlled in accordance with a speed of a following vehicle among different road users. The lane changes are changes in the driving behavior of a subject vehicle that is the host vehicle. In another comparative technology, right-left turning at an intersection is controlled for avoiding a situation where the subject vehicle is left behind the intersection, in accordance with traffic conditions. The turn is a change in the driving behavior of the subject vehicle.

### SUMMARY

A driving assistance system, a driving assistance method, a non-transitory computer-readable storage medium storing a driving assistance program for assisting driving of a host vehicle plans a behavior change that is a change in a driving behavior controlled in the host vehicle, and projects a notification image that provides notification of a transition state of the behavior change onto a traveling road to cause a different road user to recognize the notification image, the different road user being expected to interact with the host vehicle.

### BRIEF DESCRIPTION OF THE DRAWINGS

The above and other features of the present disclosure will become more apparent from the following detailed description made with reference to the accompanying drawings, in which like parts are designated by like reference numbers.

FIG. 1 is a block diagram showing a physical configuration of a driving assistance system according to an embodiment.

FIG. 2 is a schematic diagram showing a traveling environment of a host vehicle according to the embodiment.

FIG. 3 is a block diagram showing a functional configuration of a driving assistance system according to the embodiment.

FIG. 4 is a flowchart showing a driving assistance flow according to the embodiment.

FIG. 5 is a schematic diagram for illustrating the driving assistance flow according to the embodiment.

FIG. 6 is a schematic diagram for illustrating the driving assistance flow according to the embodiment.

FIG. 7 is a schematic diagram for illustrating the driving assistance flow according to the embodiment.

FIG. 8 is a schematic diagram for illustrating the driving assistance flow according to the embodiment.

FIG. 9 is a schematic diagram for illustrating the driving assistance flow according to the embodiment.

FIG. 10 is a schematic diagram for illustrating the driving assistance flow according to the embodiment.

### DETAILED DESCRIPTION

In both technologies described above, the different road user is difficult to visually recognize the changes in the driving behavior planned for the subject vehicle. Therefore, there is a concern that an occurrence of unexpected interactions prevents ensuring the safety and security between the subject vehicle and the different road user.

One example of the present disclosure provides a driving assistance system ensures safety and security in interaction between a host vehicle and a different road user. Another example of the present disclosure provides a driving assistance method that ensures the safety and security in interactions between the host vehicle and the different road user. Further, another example of the present disclosure provides a driving assistance program that ensures the safety and security in interactions between the host vehicle and the different road user.

According to a first example embodiment of the present disclosure, a driving assistance system for assisting driving of a host vehicle includes a processor configured to: plan a behavior change that is a change in a driving behavior controlled in the host vehicle; and project a notification image that provides notification of a transition state of the behavior change onto a traveling road to cause a different road user to recognize the notification image, the different road user being expected to interact with the host vehicle.

According to a second example embodiment of the present disclosure, a driving assistance method is implemented by a processor for assisting driving of a host vehicle, and the method includes: planning a behavior change that is a change in a driving behavior controlled in the host vehicle; and projecting a notification image that provide notification of a transition state of the behavior change onto a traveling road to cause a different road user to recognize the notification image, the different road user being expected to interact with the host vehicle.

According to a third example embodiment of the present disclosure, a non-transitory computer-readable storage medium stores a driving assistance program stored in a storage medium for assisting driving of a host vehicle, the driving assistance program including instructions for causing a processor to: plan a behavior change that is a change in a driving behavior controlled in the host vehicle; and project a notification image that provide notification of a transition state of the behavior change onto a traveling road to cause a different road user to recognize the notification image, the different road user being expected to interact with the host vehicle.

Thus, according to the first to third example embodiments, the behavior change is planned, which is a change in driving behavior controlled in the host vehicle. Therefore, in the first to third example embodiment, the notification image that provides notification of the transition state of the behavior change is projected onto the traveling road as an image that can be recognized by the different road user that is expected to interact with the host vehicle. Therefore, by recognizing the notification image, the different road user can grasp the transition status of the behavior change planned in the host vehicle in a timely manner. Thereby, it is possible to ensure the safety and security in the interaction between the host vehicle and the different road user.

Hereinafter, an embodiment of the present disclosure will be described with reference to the drawings.

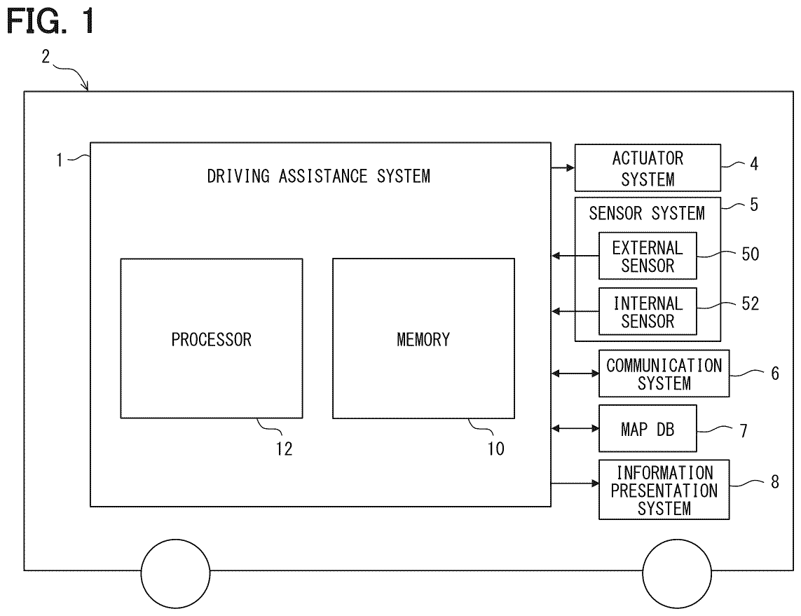

A driving assistance system 1 of an embodiment shown in FIG. 1 assists driving of a host vehicle 2. At least a part of the driving assistance system 1 is installed in the host vehicle 2. The host vehicle 2 to which the driving assistance system 1 is applied may achieve a level of automated driving specified in, for example, SAE J3016, in which, in addition to automated driving tasks, there are manual driving assistance tasks that assist the operator in manual driving operations. The host vehicle 2 here is a road user, such as a car or truck, and may be referred to as a subject vehicle (also referred to as an ego-vehicle) from a perspective that centers the host vehicle 2. Therefore, in the driving assistance system 1 of the present embodiment, the driver who sits in the driver's seat of the host vehicle 2 and can perform manual driving operations is the target of driving assistance as the operator of the host vehicle 2.

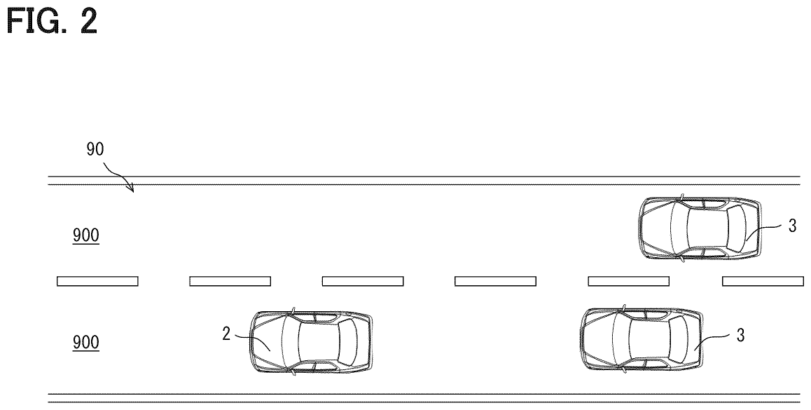

As shown in FIG. 2, in a traffic environment in which the host vehicle 2 travels, a traffic scene in which a different road user (also referred to as other road user) 3 other than the host vehicle 2 exist is assumed. The different road user 3 includes a non-vulnerable road user and a vulnerable road user according to the vulnerability. The non-vulnerable road user is at least one type of a mobile object with human occupants, such as, for example, cars, trucks, motorcycles, and bicycles. The vulnerable user is a human being, such as a pedestrian. Such the different road user 3 may be in either a stationary state or a moving state in an envisaged traffic scene.

As shown in FIG. 1, the host vehicle 2 is equipped with an actuator system 4, a sensor system 5, a communication system 6, a map database (DB) 7, and an information presentation system 8 together with at least a part of the driving assistance system 1. However, FIG. 1 representatively illustrates an example in which the entire driving assistance system 1, implemented in the form of a driving assistance device such as a processing device (for example, a processing ECU or the like) or a semiconductor device (for example, a semiconductor chip or the like), is mounted on the host vehicle 2.

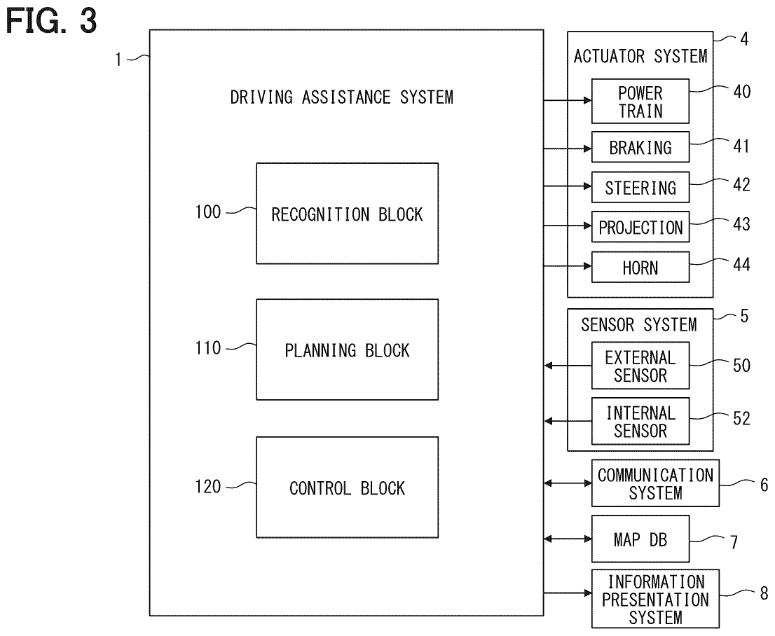

The actuator system 4 shown in FIGS. 1 and 3 is configured to control the host vehicle 2 based on a control instruction given from the driving assistance system 1. The actuator system 4 may be at least one type of powertrain actuator 40, for example, an internal combustion engine, a motor generator motor, or the like. The actuator system 4 may be at least one type of braking actuator 41, such as for example a brake unit. The actuator system 4 may be at least one type of steering actuator 42, such as a power steering unit or the like. The actuator system 4 may be at least one type of projection actuator 43, such as for example an adaptive headlight unit or a projection unit. The actuator system 4 may be at least one type of horn actuator 44, for example, such as an electronic horn unit.

The sensor system 5 senses the external and internal environments of the host vehicle 2 to acquire sensing information that can be used in the driving assistance system 1. Therefore, the sensor system 5 includes an external sensor 50 and an internal sensor 52.

The external sensor 50 senses targets present in the external environment of the host vehicle 2. The target sensing type external sensor 50 is at least one of, for example, an in-vehicle camera, a LIDAR (light detection and ranging/laser imaging detection and ranging), a laser sensor, a millimeter wave sensor, and a sonar sensor. The target sensing type external sensor 50 may be implemented in a combination of multiple types so as to sense the front, sides, and rear directions of the host vehicle 2.

The internal sensor 52 senses a specific physical quantity of motion related to vehicle motion in the internal environment of the host vehicle 2. The motion sensing type internal sensor 52 is at least one of, for example, a speed sensor, an acceleration sensor, a gyro sensor, an inertial sensor, or the like. The internal sensor 52 may sense the operations or states of the occupants including the driver in the internal environment of the host vehicle 2. The occupant sensing type internal sensor 52 is at least one of, for example, an accelerator pedal sensor, a brake pedal sensor, a shift sensor, a steering angle sensor, a steering torque sensor, an occupant camera, an occupant seat switch, a gesture sensor, a biometric sensor, or a seating sensor.

The communication system 6 acquires communication information available for the driving assistance system 1 via wireless communication. The communication system 6 may receive a positioning signal from an artificial satellite of a global navigation satellite system (GNSS) present in the outside of the host vehicle 2. The positioning type communication system 6 is, for example, a GNSS receiver. The communication system 6 may transmit and receive a communication signal to and from a V2X system present in the outside of the host vehicle 2. The communication system 6 of the V2X communication type may be at least one of a dedicated short range communications (i.e., DSRC) device, a cellular V2X (i.e., C-V2X) communication device, or the like, for example. The communication system 6 may transmit and receive a communication signal to and from a mobile terminal present in the inside of the host vehicle 2. The terminal communication type communication system 6 is at least one of, for example, a Bluetooth (registered trademark) device, a Wi-Fi (registered trademark) device, or an infrared communication device.

The map DB 7 stores map information available for the driving assistance system 1. The map DB 7 includes at least one non-transitory tangible storage medium among, for example, a semiconductor memory, a magnetic medium, and an optical medium. The map DB 7 may be a DB for a locator that estimates the self-position of the host vehicle 2. The map DB may be a DB of a navigation unit that navigates the traveling route of the host vehicle 2. The map DB 7 may be constructed by a combination of multiple DBs.

The map DB 7 downloads digital maps as needed, for example, by V2X communication with an external center via the communication system 6, and updates the map information. The map information is converted into two-dimensional or three-dimensional data as information representing the external environment in which the host vehicle 2 is traveling. As the three-dimensional map information, digital data of a high precision map may be used. The map information includes road information indicating at least one of a position, a shape, or a size of a road. The map information may include structure information that indicates at least one of, for example, the positions, shapes, sizes, or the like of buildings and traffic lights facing the road. The map information may include road marking information that indicates at least one of the positions, shapes, or sizes of signs and dividing lines attached to the road.

The information presentation system 8 presents notification information to occupants including the driver of the host vehicle 2. The information presentation system 8 presents notification information to the occupants of the host vehicle 2 by stimulating their visual senses. The visual information presentation type information presentation system 8 is at least one of, for example, an in-vehicle monitor, a head-up display (HUD), a combination meter, a navigation unit, an illumination unit, or the like. The information presentation system 8 may present notification information by stimulating the occupant's auditory. The auditory information presentation type information presentation system 8 is, for example, at least one of a speaker, a buzzer, a vibration unit, and the like. The information presentation system 8 may present the notification information by stimulating the occupant's skin sensibility. The information presentation system 8 having a skin sensibility information presentation type is at least one of, for example, a vibration unit, a reaction force unit, or an air conditioning unit.

The driving assistance system 1 is connected to the actuator system 4, the sensor system 5, the communication system 6, the map DB 7, and the information presentation system 8 via at least one of a LAN (Local Area Network), a wire harness, an internal bus, a wireless communication line, and the like. The driving assistance system 1 includes at least one dedicated computer.

The dedicated computer that configures the driving assistance system 1 may be an integrated Electronic Control Unit (ECU) that integrally controls the driving of the host vehicle 2. The dedicated computer constituting the driving assistance system 1 may be a sensing ECU that processes sensing information in driving control of the host vehicle 2. The dedicated computer that constitutes the driving assistance system 1 may be a recognition ECU that recognizes the external environment in driving control of the host vehicle 2. The dedicated computer that configures the driving assistance system 1 may be a locator ECU that estimates the self-position of the host vehicle 2.

The dedicated computer constituting the driving assistance system 1 may be a planning ECU that plans driving control of the host vehicle 2. The dedicated computer constituting the driving assistance system 1 may be a navigation ECU that navigates a traveling route in driving control of the host vehicle 2. The dedicated computer constituting the driving assistance system 1 may be an actuator ECU that controls the actuator system 4 as part of driving control of the host vehicle 2.

The dedicated computer constituting the driving assistance system 1 may be an information management ECU that controls the information presentation system 8 as part of driving control of the host vehicle 2. The dedicated computer constituting the driving assistance system 1 may be at least one external computer that constructs an external center or a mobile terminal capable of communicating via, for example, the communication system 6.

The dedicated computer constituting the driving assistance system 1 includes at least one memory 10 and at least one processor 12. The memory 10 is at least one type of non-transitory tangible storage medium of, for example, a semiconductor memory, a magnetic medium, and an optical medium, for non-transitory storage of computer readable programs, data, and the like. The processor 12 includes, as a core, at least one of, for example, a CPU (Central Processing Unit), a GPU (Graphics Processing Unit), an RISC (Reduced Instruction Set Computer) CPU, and the like.

The processor 12 executes multiple instructions included in a driving assistance program stored in the memory 10 as software. As a result, the driving assistance system 1 constructs multiple functional blocks for executing the driving assistance process for the host vehicle 2. The multiple functional blocks thus constructed by the driving assistance system 1 include a recognition block 100, a planning block 110, and a control block 120, as shown in FIG. 3.

The recognition block 100 acquires sensing information from the sensor system 5. The recognition block 100 acquires communication information from the communication system 6. The recognition block 100 acquires map information stored in the map DB 7. The recognition block 100 acquires from the memory 10 past information on control instructions by the control block 120 to the host vehicle 2. The recognition block 100 processes these acquired information individually and then fuses them to recognize the state of the external and internal environments for each traveling scene of the host vehicle 2, and generates recognition data.

Specifically, the recognition block 100 generates recognition data by localization that recognizes the self-state including the self-position of the host vehicle 2. The recognition data regarding the own state may represent at least one type of its self-position (longitude and latitude and altitude), attitude angle, steering angle, speed, acceleration, jerk, and yaw rate of the host vehicle 2 in response to the control instructions in the control block 120.

The recognition block 100 generates recognition data by recognizing targets including the different road user 3, obstacles, and structures that exist in the external environment of the host vehicle 2. The recognition data regarding the target may represent at least one type of physical quantity of motion among, for example, a separation distance, a direction of motion, a relative velocity, a relative acceleration, or a time to collision. The recognition data for the targets may represent classifications of targets clustered based on their motion physics.

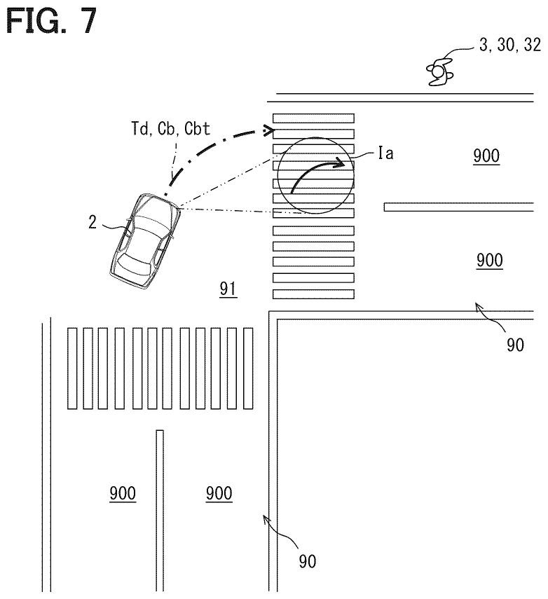

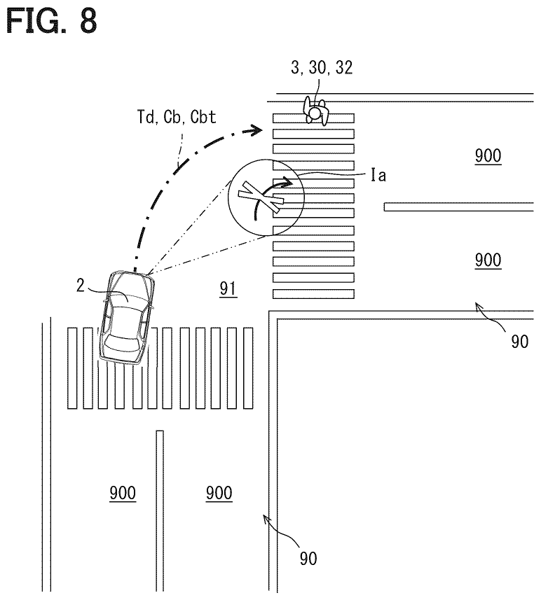

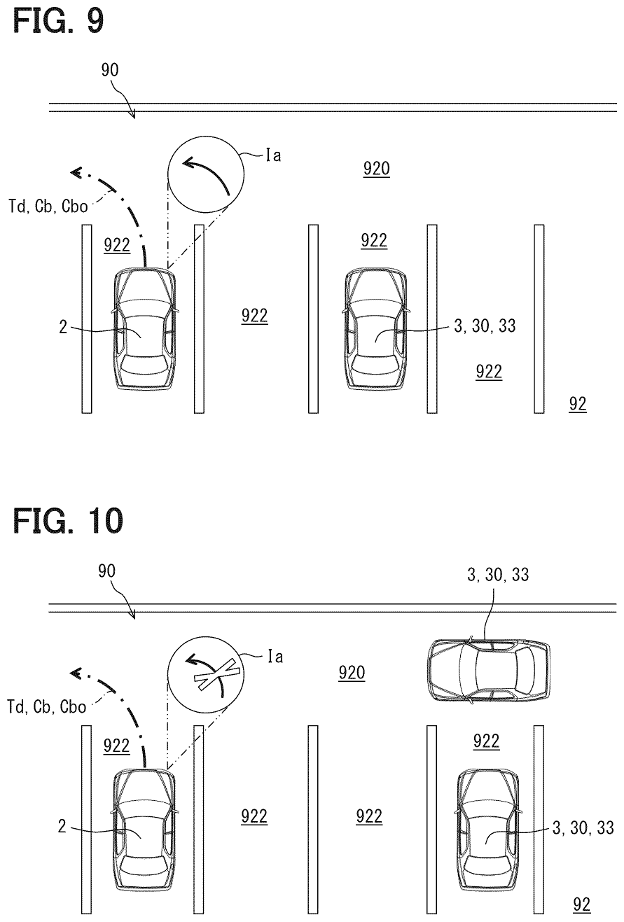

The recognition block 100 generates recognition data by recognizing the road on which the host vehicle 2 is traveling. The recognition data related to the road may represent at least one type of road structure. In particular, the road-related recognition data may represent at least one type of road structure, such as the number, position, width, length, shape, curvature, curve radius, and nodes, of traveling lanes 900 (see FIG. 2 and FIGS. 5 and 6 described below) that constitute a traveling road 90 of the general road on which the host vehicle 2 and the different road user 3 travel. The road-related recognition data may represent at least one type of road structure, such as the position of an intersection 91 (see FIGS. 7 and 8 described later) among nodes of the traveling road 90 through which the host vehicle 2 and different road user 3 pass on a general road, the width and node state of the traveling road 90, the width and node state of the traveling lane 900, the width of a pedestrian walkway, and the width of a crosswalk. The road-related recognition data may represent at least one type of road structure, such as the position, width, length, shape, and nodes, of an aisle space 920 and parking spaces 922 (see FIGS. 9 and 10 described later) that constitute the traveling road 90 within a parking facility 92.

The recognition block 100 generates recognition data by recognizing road markings associated with the road along which the host vehicle 2 travels. The recognition data regarding road markings may represent at least one type of marking state among road signs, dividing lines, and traffic lights, for example. The recognition data on road markings may further represent at least one of, for example, direction of travel, speed limit, or stopping positions that are the traffic rules recognized from the marking states. Based on these, in particular, it is preferable that the recognition data related to the traveling road 90 on general road (see FIGS. 2, 5 and 6) includes identification data for identifying the traveling lane 900 in which the host vehicle 2 and the different road user 3 are respectively traveling. The recognition data for the intersection 91 (see FIGS. 7 and 8) on the traveling road 90 of a general road may include identification data for identifying the passing positions through which the host vehicle 2 and the different road user 3 pass. The recognition data related to the traveling road 90 within the parking facility 92 (see FIGS. 9 and 10) may be accompanied by identification data that identifies at least one of a parking space 922 in an empty state, a parking space 922 in a parked or stopped state, or the aisle space 920 in which the host vehicle 2 and/or different road user 3 are traveling.

In addition to the above, the recognition block 100 generates recognition data by recognizing the actions of the driver as an operator with respect to the host vehicle 2. In particular, the recognition data related to the driver operation that provides a manual driving assistance task to the host vehicle 2 may represent at least one of, for example, accelerator pedal operation amount, brake pedal operation amount, shift position, steering angle, or steering torque. In addition, the recognition data related to the driver operation to switch the driving task provided to the host vehicle 2 between an automated driving task and a manual driving assistance task may represent the operation state of at least one type of passenger seat switch, such as a task switching switch and an assist switch, for example.

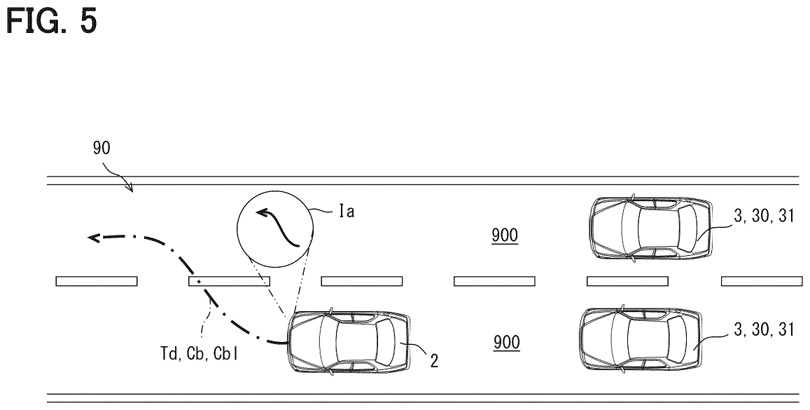

The planning block 110 shown in FIG. 3 acquires the recognition data from the recognition block 100. The planning block 110 acquires past information on control instructions to the host vehicle 2 by reading it from the memory 10. Based on the acquired data and information, the planning block 110 plans a target driving trajectory Td (see FIGS. 5 to 10) for the future travel of the host vehicle 2.

The driving trajectory Td specifies the time series changes in the motion parameters targeted as the self-state of the host vehicle 2 for each control period expected in the future beyond the present. Specifically, the driving trajectory Td may represent the position coordinates of the path that the host vehicle 2 is to follow in the future for each control period. Furthermore, the driving trajectory Td may represent at least one type of motion physical quantity, such as speed, acceleration, jerk, yaw rate, and yaw angle, as a motion parameter to be generated for each control period on such a trajectory, for example.

The control block 120 shown in FIG. 3 acquires the recognition data from the recognition block 100. The control block 120 acquires data of the driving trajectory Td from the planning block 110. The control block 120 acquires past information on control instructions to the host vehicle 2 by reading it from the memory 10. The control block 120 generates control instructions to be set in the host vehicle 2 based on the acquired data and information. At this time, a control instruction is generated to be issued to the actuator system 4 so as to control driving behavior in accordance with the automated driving level, which is adjusted to suit the traveling scene, among the automated driving tasks and manual driving assistance tasks in the host vehicle 2. The control instruction data thus generated is stored in the memory 10.

Examples of control of driving behavior according to the level of automated driving include, for example, adaptive cruise control, autonomous emergency braking, lane keeping assist, lane change assist, right/left turn assist, and parking assist. Therefore, the adjustment of the automated driving level may include a handover of the driving task between the driving assistance system 1 and the driver by transitioning the driving mode between the autonomous driving task and the manual driving assistance task. Such a handover may be implemented at least at one of the times of, for example, a time when a handover request is made by the driver, an entering/leaving time for the operational design domain (ODD) of the automated driving, or a time when a minimum risk manoeuvre (MRM) is required.

### (Driving Assistance Flow)

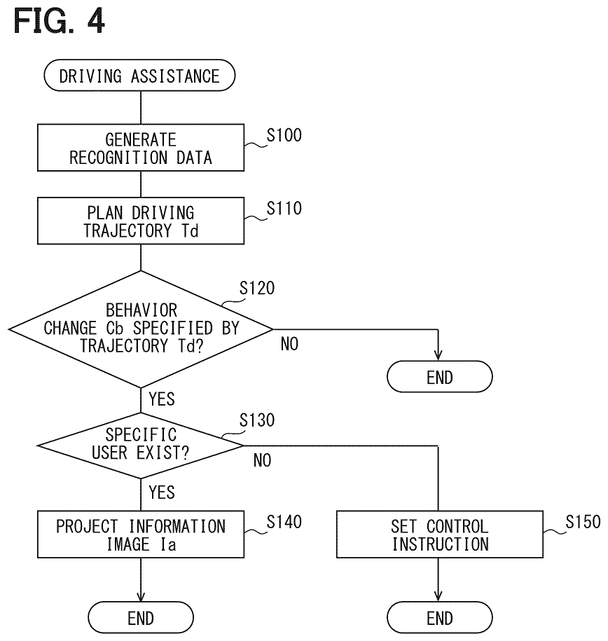

The driving assistance method in which the driving assistance system 1 controls the host vehicle 2 by cooperating with the blocks 100, 110, and 120 described above is repeatedly executed according to the driving assistance flow shown in FIG. 4. In the following description, each “S” in the driving assistance flow means multiple processes executed by multiple instructions included in the driving assistance program.

In S100, the recognition block 100 generates recognition data that recognizes the state of the external and internal environments in the current traveling scene of the host vehicle 2. In S110, the planning block 110 plans the driving trajectory Td of the host vehicle 2 from the current traveling scene to future traveling based on the recognition data (hereinafter simply referred to as recognition data) generated by at least S100 of the current flow, of the current flow and the past flow.

In S120, the control block 120 determines whether the driving trajectory Td planned in S110 of the current flow defines a specific behavior change Cb in the host vehicle 2. In this case, the specific behavior change Cb is defined as a change in driving behavior controlled by the control block 120 in the host vehicle 2, and requires the projection of a notification image Ia (see FIGS. 5 to 10) described in detail later. Therefore, the specific behavior change Cb may occur, for example, in response to a transition from a manual driving assistance task to an automated driving task in response to the operation of a task switching switch or an assist switch, or in response to a change in the automated driving task related to driving behavior.

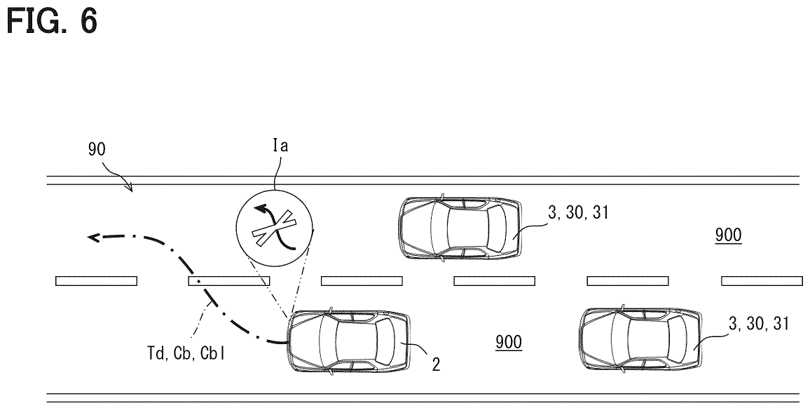

Specifically, the specific behavior change Cb may be a lane change Cbl in which the host vehicle 2 moves from the traveling lane 900 in which it is currently traveling to another traveling lane 900 on the traveling road 90 with multiple parallel traveling lanes 900 as shown in FIGS. 5 and 6. As shown in FIGS. 7 and 8, the specific behavior change Cb may be a turning Cbt defined as a right or left turn in which the host vehicle 2 turns from the traveling lane 900 in which it is currently traveling to another traveling lane 900 at the intersection 91. At the intersection 91, two traveling roads 90, each having at least one traveling lane 900, intersect at a node. As shown in FIGS. 9 and 10, the specific behavior change Cb may be an exit Cbo from the parking space 922, in which the host vehicle 2 parked or stopped in the parking space 922 starts toward the aisle space 920.

As shown in FIG. 4, when a negative determination is made in S120, the current flow ends. On the other hand, when a positive determination is made in S120, the current flow proceeds to S130. In S130, the control block 120 determines whether a specific user 30 exists in accordance with the specific behavior change Cb confirmed in S120 of the current flow. The specific user is the different road user 3 predicted to interact with the host vehicle 2. At this time, the presence or absence of the specific user 30 is determined based on the recognition data.

Specifically, when the specific behavior change Cb is the lane change Cbl shown in FIGS. 5 and 6, the presence or absence of a rear user 31 traveling behind the host vehicle 2 is determined as the specific user 30. In this case, the rear user 31 may be another vehicle that travels in an adjacent traveling lane 900 different from the host vehicle 2 and moves within a set distance behind the host vehicle 2. The rear user 31 may be the other vehicle traveling behind the host vehicle 2 within a set distance in the common traveling lane 900 with the host vehicle 2.

When the specific behavior change Cb is the turning Cbt at the intersection 91 shown in FIGS. 7 and 8, the presence or absence of intersection user 32 is determined. The intersection user 32 is the specific user 30 present at the intersection 91 where the host vehicle 2 enters and in its periphery. In this case, the intersection user 32 may be either a person or a bicycle moving on a pedestrian walkway or crosswalk on the turning destination defined as the right or left turn destination of the host vehicle 2 at the intersection 91 on the driving trajectory Td according to S110 of the current flow. The intersection user 32 may be another vehicle traveling in the traveling lane 900 opposite the host vehicle 2 and within a set distance ahead of the host vehicle 2.

When the specific behavior change Cb is the exit Cbo from the parking space 922 to the aisle space 920 shown in FIGS. 9 and 10, the presence or absence of a peripheral user 33 present in the periphery of the parking space 922 in which the host vehicle 2 is parked or stopped is determined as the specific user 30. In this case, the peripheral users 33 may be other vehicles, people, or bicycles moving within a set distance from the host vehicle 2 in the aisle space 920 which is the exit point for the host vehicle 2 from the parking space 922 in which it is parked or stopped. The peripheral user 33 may be another vehicle parked or stopped in the parking space 922 other than the host vehicle 2.

As shown in FIG. 4, when a positive determination is made in S130, the current flow proceeds to S140. In S140, the control block 120 projects the notification image Ia, which notifies the transition state of the specific behavior change Cb confirmed in S120 of the current flow, onto the traveling road 90 from the projection actuator 43 so that it is recognizable by the specific user 30 confirmed in S130 of the current flow.

Specifically, when the specific behavior change Cb is the lane change Cbl, as shown in FIGS. 5 and 6, the notification image Ia notifying the transition state of the lane change Cbl is projected onto the road surface in the adjacent traveling lane 900 different from the host vehicle 2. At this time, when, based on the recognition data, it is predicted that the rear user 31 that is the specific user 30 and traveling in the adjacent traveling lane 900 different from the host vehicle 2 does not interfere with the lane change Cbl until the completion, the control block 120 sets the control instruction according to the driving trajectory Td while the planning block 110 maintains the plan of S110 in the current flow. Therefore, in the case of non-interference prediction, the notification image Ia is projected so as to indicate the continuation state of the lane change Cbl with a graphic (see FIG. 5) and/or text.

On the other hand, when it is predicted based on the recognition data that the rear user 31, which is the specific user 30 and is traveling in the different traveling lane 900 from the host vehicle 2, affects the lane change Cbl, the control block 120 sets a control instruction according to the driving trajectory Td replanned by the planning block 110 so as to temporarily hold the lane change Cbl. Therefore, in a transition state in which the lane change Cbl in response to the interference prediction is temporarily held, the notification image Ia is projected to indicate the hold state with graphics (see FIG. 6) and/or text. At this time, the control block 120 may set a control instruction to temporarily return the steering angle of the tires of the host vehicle 2 to the opposite position to the lane change Cbl in response to the temporal hold of the lane change Cbl. Furthermore, in the case of interference prediction, when the lane change Cbl is temporarily held and then resumed, the notification image Ia may be projected to indicate the transition state up to the resumption in graphics and/or character.

When the specific behavior change Cb is the turning Cbt at the intersection 91, the notification image Ia for notification of the transition state of the turning Cbt as shown in FIGS. 7 and 8 is projected onto the road surface of the intersection 91 where the host vehicle 2 is turning. At this time, when, based on the recognition data, it is predicted that the intersection user 32, which is the specific user 30 and exists close to turning destination of the host vehicle 2, does not interfere with the turning Cbt until the completion, the control block 120 sets the control instruction according to the driving trajectory Td while the planning block 110 maintains the plan of S110 in the current flow. Therefore, in the case of non-interference prediction, the notification image Ia is projected so as to represent the continuation state of the turning Cbt with a graphic (see FIG. 7) and/or a character.

On the other hand, when the intersection user 32 existing on the turning side of the host vehicle 2 as the specific user 30 is predicted to interfere with the turning Cbt based on the recognition data, the control block 120 sets the control instruction according to the driving trajectory Td replanned by the planning block 110 so as to temporarily hold the turning Cbt. Therefore, in the transition state of a temporal stop of the turning Cbt in response to the case of interference prediction, the notification image Ia is projected so as to represent the stop state with a graphic (see FIG. 8) and/or a character. At this time, the control block 120 may set the control instruction to temporarily return the steering angle at which the tires of the host vehicle 2 are directed to the origin angle along the roll axis of the host vehicle 2 in response to the temporal stop of the turning Cbt. Furthermore, in the case of interference prediction, when the turning Cbt is temporarily stopped and then resumed, the notification image Ia may be projected to represent the transition state up to the resumption with graphics and/or character.

When the specific behavior change Cb is the exit Cbo from the parking space 922 to the aisle space 920, the notification image Ia notifying the transition state of the exit Cbo is projected onto the road surface of the aisle space 920, which is the exit destination, as shown in FIGS. 9 and 10. At this time, when, based on the recognition data, it is predicted that the peripheral user 33 that is the specific user 30 and exists in the periphery of the exit destination of the parking space 922 where the host vehicle 2 is parked or stopped does not interfere with the exit Cbo until the completion, the control block 120 sets the control instruction according to the driving trajectory Td while the planning block 110 maintains the plan of S110 in the current flow. Therefore, in the case of non-interference prediction, it is preferable that the notification image Ia is projected so as to indicate a continuation state of the exit Cbo with a graphic (see FIG. 9) and/or a character.

On the other hand, when it is predicted that the peripheral user 33 that is the specific user 30 exists in the periphery of the exit destination of the parking space 922 in which the host vehicle 2 is parked or stopped, is predicted to interfere with the exit Cbo based on the recognition data, the control block 120 sets the control instruction according to the driving trajectory Td replanned by the planning block 110 so as to temporarily hold the exit Cbo. Therefore, in the transition state of the temporary hold of the exit Cbo in response to the case of interference prediction, the notification image Ia is projected so as to represent the hold state with a graphic (see FIG. 10) and/or character. At this time, the control block 120 may set the control instruction to temporarily return the steering angle at which the tires of the host vehicle 2 are directed to the origin angle along the roll axis of the host vehicle 2 in response to the temporal hold of the exit Cbo. Furthermore, in the case of interference prediction, when the exit Cbo is temporarily held and then resumed, the notification image Ia may be projected to represent the transition state up to the resumption with graphics and/or character.

The control instruction indicating the specific behavior change Cb represented by the notification image Ia in S140 may be set to control at least two types of coordination among acceleration by the powertrain actuator 40, braking (i.e., deceleration) by the braking actuator 41, and steering by the steering actuator 42. In S140, along with the control instruction indicating the specific behavior change Cb represented by the notification image Ia, a control instruction for notifying the different road user 3 of the specific behavior change Cb by a warning sound from the horn actuator 44 may be set. In this way, after the completion of execution in S140, the current flow ends.

As shown in FIG. 4, when a negative determination is made in S130, the current flow proceeds to S150. In S150, the control block 120 sets a control instruction indicating the specific behavior change Cb confirmed in S120 of the current flow. In this case, the control instruction of S150 may be set in accordance with the case where non-interference is predicted for the specific user 30 corresponding to the specific behavior change Cb among the rear user 31, the intersection user 32, and the peripheral user 33 in S140. Therefore, in S150, the notification image Ia representing the transition state of the specific behavior change Cb that transitions in response to the control instruction may be projected in a manner based on the manner of S140. In S150, a control instruction may be set to provide notification of the specific behavior change Cb by a warning sound from the horn actuator 44 based on the manner of S140. In this way, after the completion of execution in S150, the current flow ends.

### Operation and Effects

The operation and effects in the present embodiment described above will be explained below.

According to the present embodiment, in particular, the specific behavior change Cb is planned as a behavior change that is a change in driving behavior controlled in the host vehicle 2. Therefore, in the present embodiment, the notification image Ia that provides notification of the transition state of the specific behavior change Cb is projected onto the traveling road 90 as an image that can be recognized by the different road user 3 that is expected to interact with the host vehicle 2. Therefore, by recognizing the notification image Ia, the different road user 3 can grasp the transition state of the specific behavior change Cb planned in the host vehicle 2 in a timely manner. Thereby, it is possible to ensure the safety and security in the interaction between the host vehicle 2 and the different road user 3.

According to the present embodiment, the lane change Cbl is planned as the specific behavior change Cb to be controlled in the host vehicle 2. Therefore, in the present embodiment, the notification image Ia is projected so as to be recognizable by the rear user 31 traveling behind the host vehicle 2 as the different road user 3 that is expected to interact with the host vehicle 2. According to this, the rear user 31 is possible to timely grasp the transition state of the lane change Cbl planned in the host vehicle 2 by recognizing the notification image Ia. Therefore, it is possible to ensure the safety and security during interaction between the host vehicle 2 and the rear user 31.

According to the present embodiment, notification of the transition state in which the lane change Cbl is temporarily held in response to the predicted interference with the lane change Cbl by the rear user 31 is provided by projecting the notification image Ia. Thereby, the rear user 31 is possible to timely grasp the transition state in which the lane change Cbl in the host vehicle 2 is temporarily held. Therefore, it is possible to increase the comprehensiveness of response scenes in ensuring the safety and security during interactions between the host vehicle 2 and the rear user 31.

In response to the temporal hold of the lane change Cbl of the transition state according to the present embodiment, a control instruction is set in the host vehicle 2 to return the steering angle of the host vehicle 2 to the angle opposite to the lane change Cbl. As a result, the rear user 31 can timely and accurately grasp the transition situation of the temporal hold of the lane change Cbl from the notification content of the notification image Ia and the tire direction according to the steering angle of the host vehicle 2. Therefore, it is possible to increase the reliability of ensuring the safety and security in the interaction between the host vehicle 2 and the rear user 31.

According to the present embodiment, the turning Cbt at the intersection 91 is planned as the specific behavior change Cb to be controlled in the host vehicle 2. Therefore, in the present embodiment, the notification image Ia is projected so as to be recognizable by the intersection user 32 close to the turning destination at the intersection 91 as the different road user 3 predicted to interact with the host vehicle 2. According to this, by recognizing the notification image Ia, the intersection user 32 can timely grasp the transition state of the turning Cbt planned in the host vehicle 2. Therefore, it is possible to ensure the safety and security in the interaction between the host vehicle 2 and the intersection user 32.

According to the present embodiment, in response to the prediction of the interference by the intersection user 32 with the turning Cbt, the notification of the transition state in which the turning Cbt is temporarily stopped is provided by projecting the notification image Ia. Thereby, the intersection user 32 is possible to timely grasp the transition state in which the turning Cbt of the host vehicle 2 is temporarily stopped. Therefore, it is possible to increase the comprehensiveness of response scenes to ensure the safety and security in interactions between the host vehicle 2 and the intersection user 32.

In response to the temporal stop of the turning Cbt of the transition state according to the present embodiment, the control instruction is set in the host vehicle 2 to return the steering angle of the host vehicle 2 towards the origin angle. As a result, the intersection user 32 can timely and accurately grasp the transition state of the temporal stop of the turning Cbt from the notification content of the notification image Ia and the tire direction according to the steering angle of the host vehicle 2. Therefore, it is possible to increase the reliability of ensuring the safety and security in the interaction between the host vehicle 2 and the intersection user 32.

According to the present embodiment, the exit Cbo from the parking space 922 is planned as the specific behavior change Cb to be controlled in the host vehicle 2. Therefore, in the present embodiment, the notification image Ia is projected so as to be recognizable by the peripheral user 33 present in the periphery of the parking space 922 as the different road user 3 expected to interact with the host vehicle 2. According to this, by recognizing the notification image Ia, the peripheral user 33 can timely grasp the transition state of the exit Cbo from the parking space 922 planned in the host vehicle 2. Therefore, it is possible to ensure the safety and security in interactions between the host vehicle 2 and the peripheral user 33.

According to the present embodiment, in response to predicted interference of the peripheral user 33 with the exit Cbo from the parking space 922, the notification of the transition state in which the exit Cbo is temporarily held is provided by projecting the notification image Ia. Thereby, the peripheral user 33 is possible to timely grasp the transition state in which the exit Cbo is temporarily held in the host vehicle 2. Therefore, it is possible to increase the comprehensiveness of response scenes to ensure the safety and security in interactions between the host vehicle 2 and the peripheral user 33.

In response to the temporal hold of the exit Cbo, from the parking space 922, of the transition state according to the present embodiment, the control instruction is set in the host vehicle 2 to return the steering angle of the host vehicle 2 towards the origin angle. Thereby, the peripheral user 33 is possible to timely and accurately grasp the transition state in which the exit Cbo is temporarily held based on the notification content of the notification image Ia and the direction of the tires according to the steering angle. Therefore, it is possible to increase the reliability of ensuring the safety and security in the interaction between the host vehicle 2 and the peripheral user 33.

### OTHER EMBODIMENTS

Although one embodiment has been described above, the present disclosure is not to be construed as being limited to the embodiment of the description, and can be applied to various embodiments within the scope not departing from the gist of the present disclosure.

In another modification, a dedicated computer constituting the driving assistance system 1 may include at least one of a digital circuit or an analog circuit, as a processor. The digital circuit is at least one type of, for example, an application specific integrated circuit (i.e., ASIC), a field programmable gate array (i.e., FPGA), a system on a chip (i.e., SOC), a programmable gate array (i.e., PGA), a complex programmable logic device (i.e., CPLD), and the like. Such a digital circuit may also include a memory in which a program is stored.

In a modification, the operator who manually drives the host vehicle 2 to which the driving assistance system 1 is applied may be a remote operator who remotely controls the driving of the host vehicle 2 from an external center. In the modification, the driving assistance system 1 may be configured to implement only automated driving tasks, without the existence of manual driving assistance tasks that assist the operator in performing manual driving operations.

What is claimed is:

1. A driving assistance system for assisting driving of a host vehicle, the system comprising
a processor configured to:
plan a behavior change that is a change in a driving behavior controlled in the host vehicle; and
project a notification image that provides notification of a transition state of the behavior change onto a traveling road to cause a different road user to recognize the notification image, the different road user being expected to interact with the host vehicle.

2. The driving assistance system according to claim 1, wherein
a plan of the behavior change includes a plan of a lane change that is the behavior change controlled in the host vehicle, and
projection of the notification image includes projection of the notification image that provides the notification of the transition state of the lane change to cause a rear user traveling behind the host vehicle to recognize the notification image, the rear user being the different road user predicted to interact with the host vehicle.

3. The driving assistance system according to claim 2, wherein
the projection of the notification image includes projection of the notification image that provides the notification of the transition state in which the lane change is temporarily held in response to a prediction of interference by the rear user with the lane change.

4. The driving assistance system according to claim 3, wherein
the processor is further configured to set a control instruction to the host vehicle to return a steering angle of the host vehicle toward an angle opposite to an angle for the lane change in response to temporal hold of the lane change.

5. The driving assistance system according to claim 1, wherein
a plan of the behavior change includes a plan of a turning that is the behavior change controlled in the host vehicle and is a right turning or a left turning at an intersection, and
projection of the notification image is projection of the notification image that provides the notification of the transition state of the turning to cause the intersection user close to a turning destination at the intersection to recognize the notification image, the intersection user being the different road user predicted to interact with the host vehicle.

6. The driving assistance system according to claim 5, wherein
the projection of the notification image includes projection of the notification image that provides the notification of the transition state in which the turning is temporarily stopped in response to a prediction of interference by the intersection user with the turning.

7. The driving assistance system according to claim 6, wherein
the processor is further configured to set a control instruction to the host vehicle to return a steering angle of the host vehicle toward an origin angle in response to temporal stop of the turning.

8. The driving assistance system according to claim 1, wherein
a plan of the behavior change includes a plan of an exit from a parking space,
the exit is the behavior change controlled in the host vehicle, and
projection of the notification image includes projection of the notification image that provides the notification of the transition state of the exit to cause a peripheral user in a periphery of the parking space to recognize the notification image, the peripheral user being the different road user predicted to interact with the host vehicle.

9. The driving assistance system according to claim 8, wherein
the projection of the notification image includes projection of the notification image that provides the notification of the transition state in which the exit is temporarily held in response to a prediction of interference by the peripheral user with the exit.

10. The driving assistance system according to claim 9, wherein
the processor is further configured to set a control instruction to the host vehicle to return a steering angle of the host vehicle toward an origin angle in response to temporal hold of the exit.

11. A driving assistance method that is implemented by a processor for assisting driving of a host vehicle, the method comprising:
planning a behavior change that is a change in a driving behavior controlled in the host vehicle; and
projecting a notification image that provides notification of a transition state of the behavior change onto a traveling road to cause a different road user to recognize the notification image, the different road user being expected to interact with the host vehicle.

12. A non-transitory computer-readable storage medium storing a driving assistance program for assisting driving of a host vehicle, the driving assistance program including instructions for causing a processor to:
plan a behavior change that is a change in a driving behavior controlled in the host vehicle; and
project a notification image that provides notification of a transition state of the behavior change onto a traveling road to cause a different road user to recognize the notification image, the different road user being expected to interact with the host vehicle.
